(19) United States
(12) Patent Application Publication
(10) Pub. No.: US 2025/0330040 A1
(43) Pub. Date: Oct. 23, 2025

(54) INTELLIGENT ELECTRONIC DEVICE AND METHOD FOR FREQUENCY DEVIATION MONITORING IN ELECTRICAL POWER DISTRIBUTION SYSTEMS

(71) Applicant: Accuenergy (Canada) Inc., Toronto (CA)

(72) Inventors: Shaohang Cui, Toronto (CA); Yufan Wang, Toronto (CA); Ketao Li, Toronto (CA); Liang Wang, Toronto (CA)

(73) Assignee: Accuenergy (Canada) Inc., Toronto (CA)

(21) Appl. No.: 18/638,717

(22) Filed: Apr. 18, 2024

(51) Int. Cl. H02J 13/00

(52) U.S. Cl. CPC H02J 13/00002; H02J 13/00001

(57) ABSTRACT

This invention pertains to an intelligent electronic device designed for sophisticated monitoring and analysis of electrical power distribution. The device integrates at least one sensor for detecting electrical parameters from a distribution system to a load, coupled with an analog-to-digital converter to transform sensed analog signals into digital data. A processing module, linked to the converter, employs customized moving average filters to calculate the frequency of electrical power distribution, enhancing measurement accuracy by adjusting for transient fluctuations. It retrieves frequency threshold settings from memory to define operational bounds, logging frequency data around identified deviation events when measurements surpass these thresholds. This system facilitates precise frequency analysis and robust event logging, providing a comprehensive solution for maintaining electrical power distribution within defined standards.

### FIELD OF THE INVENTION

The present disclosure generally relates to the field of intelligent electronic devices for electrical utility services and, more specifically, to intelligent electronic device and method for frequency deviation monitoring in electrical power distribution systems.

### BACKGROUND

The field of electrical power distribution has continually evolved to meet the growing demand for reliable and efficient electrical energy supply. Central to this endeavor is the ability to accurately monitor and analyze the electrical parameters that characterize the flow of power from distribution systems to various loads. This monitoring is crucial not only for the operational stability of power systems but also for ensuring the safety and efficiency of power delivery.

Traditionally, the monitoring of electrical parameters, including voltage, current, and frequency, has been performed by a range of devices, from simple analog meters to more complex digital systems. However, these traditional systems often face challenges in accurately capturing rapid fluctuations in electrical parameters, primarily due to limitations in their sensing and data processing capabilities.

Therefore, further improvements to intelligent electronic devices would be desirable.

### SUMMARY OF THE INVENTION

The present invention relates to an advanced intelligent electronic device and a comprehensive system for monitoring and managing electrical power distribution, significantly enhancing operational efficiency, accuracy in frequency deviation detection, and overall power system reliability. This invention employs a synergistic approach combining state-of-the-art sensors, analog-to-digital conversion technology, and processing modules equipped with customized moving average filters to refine the accuracy of frequency measurements by mitigating the impact of short-term fluctuations and noise.

In accordance with the present disclosure, an intelligent electronic device is provided. According to an aspect of the present disclosure, the intelligent electronic device includes at least one sensor configured for sensing electrical parameters of electrical power distributed from an electrical distribution system to a load; at least one analog-to-digital converter coupled to the at least one sensor and configured for converting an analog signal output from the at least one sensor to digital data; at least one processing module coupled to the at least one analog-to-digital converter, the at least one processing module is configured to retrieve a frequency threshold configuration from a memory unit, defining operational frequency boundaries through specified lower and upper frequency thresholds to maintain predetermined operational standards; compute the frequency of the electrical power distribution from the digital data using customized moving average filters, which refine the frequency measurement by adjusting for short-term fluctuations and noise, thereby enhancing the accuracy of the frequency analysis; log the refined frequency data for periods both preceding and following a trigger event, which is activated upon the detection of frequency measurements exceeding the specified lower or upper frequency threshold, ensuring detailed and actionable logging for event analysis.

In some embodiments, the intelligent electronic device of further includes a user interface module configured to display a frequency threshold configuration interface to the user, allowing for the input and adjustment of the specified lower and upper frequency thresholds within the frequency threshold configuration.

In some embodiments, the user interface module is further configured to enable users to customize the parameters of the moving average filters, including the moving average window length and moving average update rate, wherein the moving average window length determines the number of signal cycles over which the moving average is calculated, and the moving average update rate specifies how frequently the moving average calculation is updated with new data.

In some embodiments, the user interface module is further configured to permit users to enable or disable the frequency deviation monitoring feature, thereby facilitating operational flexibility and control over the monitoring of electrical power distribution anomalies.

In some embodiments, the user interface module is further configured to enable users to configure the quantity of pre-trigger and post-trigger records, each record being the frequency calculated from data within the specified moving average window length.

In some embodiments, the intelligent electronic device further includes a data storage module for archiving the frequency deviation events, configured to systematically store log files generated upon the activation of the trigger event, wherein each log file includes timestamped entries of pre-trigger and post-trigger frequency data, providing a chronological account of the electrical power distribution's frequency before and after each detected deviation.

In some embodiments, the intelligent electronic device further includes a communication interface configured to transmit alerts or notifications based on the detection of frequency deviations that exceed the predetermined lower or upper thresholds, facilitating immediate awareness and response to potential power distribution anomalies.

In some embodiments, the communication interface is further configured to enable remote access to the frequency deviation event logs and configuration settings, allowing users to review and adjust monitoring parameters from a distance, enhancing the usability and accessibility of the device's monitoring features.

In accordance with the present disclosure, a method for monitoring and analyzing electrical power distribution using an intelligent electronic device is provided. According to an aspect of the present disclosure, the method includes the steps of sensing electrical parameters of electrical power distributed from an electrical distribution system to a load using at least one sensor; converting an analog signal output from the at least one sensor to digital data via at least one analog-to-digital converter; retrieving a frequency threshold configuration from a memory unit, which defines operational frequency boundaries through specified lower and upper frequency thresholds; computing the frequency of the electrical power distribution from the digital data using customized moving average filters to refine the frequency measurement by adjusting for short-term fluctuations and noise; logging the refined frequency data for periods both preceding and following a trigger event, activated upon the detection of frequency measurements exceeding the specified lower or upper frequency thresholds.

In some embodiments, the method further includes the step of displaying a frequency threshold configuration interface to the user via a user interface module, allowing for the input and adjustment of the specified lower and upper frequency thresholds.

In some embodiments, the method further includes the step of enabling users to customize parameters of the moving average filters, including the moving average window length and moving average update rate, through the user interface module, wherein the moving average window length determines the number of signal cycles over which the moving average is calculated, and the moving average update rate specifies the frequency at which the moving average calculation is updated with new data.

In some embodiments, the method further includes the step of permitting users to enable or disable the frequency deviation monitoring feature via the user interface module, thereby facilitating operational flexibility and control over the monitoring of electrical power distribution anomalies.

In some embodiments, the method further includes the step of configuring the quantity of pre-trigger and post-trigger records through the user interface module, with each record being the frequency calculated from data within the specified moving average window length.

In some embodiments, the method further includes the step of systematically storing log files generated upon the activation of the trigger event within a data storage module, wherein each log file includes timestamped entries of pre-trigger and post-trigger frequency data.

In some embodiments, the method further includes the step of transmitting alerts or notifications based on the detection of frequency deviations that exceed the predetermined lower or upper thresholds through a communication interface, facilitating immediate awareness and response to potential power distribution anomalies.

In some embodiments, the method further includes the step of enabling remote access to the frequency deviation event logs and configuration settings via the communication interface, allowing users to review and adjust monitoring parameters from a distance.

In accordance with the present disclosure, an electrical power monitoring and management system is provided. The system includes a plurality of intelligent electronic devices (IEDs) deployed across different areas within an electrical power distribution network, with each IED configured to sense electrical parameters including at least one of current, voltage, and frequency, compute frequency of the electrical power distribution using customized moving average filters, log the computed frequency data along with timestamped entries of pre-trigger and post-trigger events related to frequency deviations, and transmit the measured electrical parameters and logged frequency data to a central energy management module;

a central energy management module deployed in a cloud computing environment, comprising a data library database configured to store a multitude of data samples received from the deployed IEDs, wherein the data samples include a first trained set based on historical readings by one or more IEDs, a second trained set based on live readings of the one or more IEDs; the historical readings and the live readings include at least one of voltage, current and frequency value measured, along with pre-trigger and post-trigger frequency data for frequency deviation events by one or more IEDs over a period of time, each value of the historical readings and the live readings being associated with a timestamp; a machine learning processor within the central energy management module, designed to process the data samples using at least one machine learning algorithm, the machine learning processor configured to process the data samples in accordance with the at least one machine learning algorithm and output prediction of the moving average filter settings of each IED; and an action processor configured to receive predictions from the machine learning processor and adjust the moving average filter settings of each IED based on the received predictions, thereby enhancing the system's frequency deviation detection precision, and customizing IED responsiveness based on specific environmental and operational conditions.

In some embodiments, the machine learning processor is further configured to process the data samples in accordance with the at least one machine learning algorithm and output at least one prediction of frequency stability in the different areas within an electrical power distribution network in a predetermined future time interval based on the data samples received; and the action processor is further configured to receives the at least one prediction of at least one prediction of frequency stability from the machine learning processor and perform at least one action based on the at least one prediction of frequency stability, wherein the action includes generating at least one control signal and outputting the at least one control signal to at least one of the one or more IEDs, wherein the control signal is configured to shut off one or more loads associated with the at least one of the one or more IEDs when the at least one prediction of frequency stability is above a predetermined threshold.

In some embodiments, the electrical power monitoring and management system further includes a server including at least one memory and at least one processor, the data library database stored in the at least one memory and the machine learning processor and the action processor executed by the at least one processor.

In some embodiments, the at least one machine learning algorithm includes at least one of an Artificial Neural Network, Deep Learning, a Convolutional Neural Network, a Recurrent Neural Network, and/or an Evolution Algorithm.

By leveraging machine learning for predictive analysis and automated adjustment of device settings, this invention represents a significant advancement in electrical power distribution management. It not only ensures the stability and reliability of the power supply but also empowers operators to proactively address potential issues, thereby maintaining optimal system performance and extending the longevity of the power distribution infrastructure.

### BRIEF DESCRIPTION OF THE DRAWINGS

The forgoing and other advantages of the present disclosure will become apparent upon reading the following detailed description and upon reference to the drawing.

FIG. 1 depicts a user interface of an intelligent electronic device designed for configuring the frequency deviation monitoring feature.

FIG. 2 illustrates an example of frequency deviation recording, represented graphically with the x-axis denoting time and the y-axis indicating frequency, demonstrating how pre-trigger and post-trigger data is captured and logged surrounding a frequency deviation event.

FIG. 3 details a user interface for configuring moving average filters within an intelligent electronic device, highlighting the ability for users to set parameters such as moving average window length and update rate, crucial for precise frequency calculation.

FIG. 4 presents a methodology for calculating frequency using configured moving average window length and update rate parameters, applied to an electrical signal, illustrating the influence of these settings on the process of data capture and analysis.

FIG. 5 shows a user interface that allows users to access critical information regarding frequency deviation events recorded by the device, including functionality for searching event logs within a specified time frame.

FIG. 6 depicts a user interface for managing frequency deviation event log files, featuring a table that organizes key information such as file name, creation time, and file size, along with options for downloading or deleting log files.

FIG. 7 provides a visualization of the contents within a log file for frequency deviation detection, displaying sequences of pre-trigger and post-trigger frequency measurements, and settings for the moving average frequency analysis.

FIG. 8 is a block diagram illustrating the internal components of an intelligent electronic device.

FIG. 9 is a diagram illustrating an exemplary electrical power monitoring and management system.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimension, and materials are illustrated for the various elements, those skilled in the art will recognize that many of the examples provided have suitable alternatives that may be utilized.

As used herein, Intelligent Electronic Devices (“IEDs”) can be any device that senses electrical parameters and computes data including, but not limited to, Programmable Logic Controllers (“PLCs”), Remote Terminal Units (“RTUs”), electrical energy meters, protective relays, fault recorders, phase measurement units, and other devices which are coupled with power distribution networks to control and manage the distribution or consumption of electrical power.

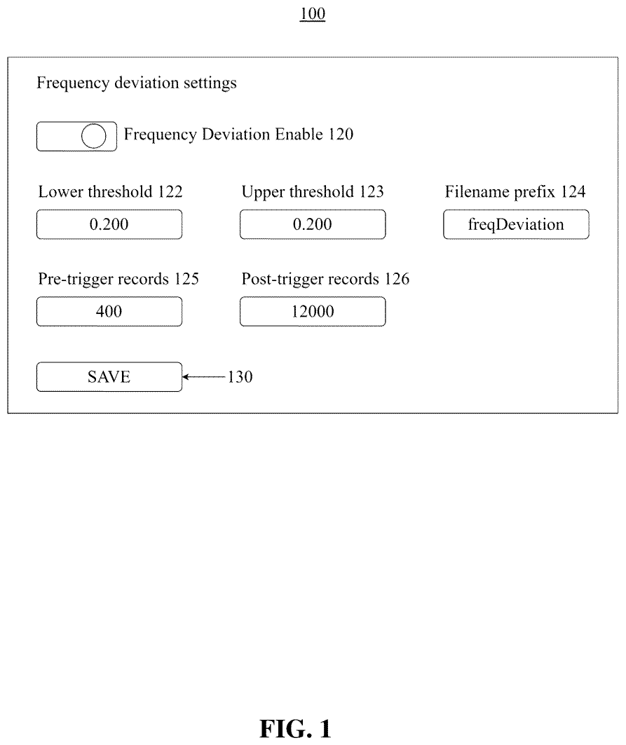

FIG. 1 provides an exemplary depiction of a user interface 100 designed for configuring the frequency deviation monitoring feature within an intelligent electronic device, such as an electrical energy meter, Central to the interface is a radio button 120, strategically positioned to enable users to activate or deactivate the frequency deviation monitoring feature according to specific requirements. This interface, adaptable for presentation on the device's physical display or within a device configuration webpage, offers a user-centric design that enables intuitive interaction and configuration by the end-user.

Beneath the activation radio button 120, the interface includes several user-input fields (122-126) designed for custom configuration. The “Lower threshold” field 122 permits users to set a minimum frequency deviation threshold. By default, this threshold is preset at 0.2 Hz, as illustrated in FIG. 1, tailored for electrical systems operating at a nominal frequency of 50 Hz. Accordingly, should the energy meter detect a frequency falling below 49.8 Hz (50 Hz−0.2 Hz), it will trigger and log a lower frequency deviation event.

Similarly, the “Upper threshold” field 123 enables the specification of a maximum frequency deviation threshold, with a default setting of 0.2 Hz, as depicted in FIG. 1. This configuration implies that any frequency exceeding 50.2 Hz (50 Hz+0.2 Hz) will prompt an upper frequency deviation event log by the device.

In some embodiments, the intelligent electronic device is equipped with a communication interface designed to detect and respond to frequency deviations by transmitting alerts or notifications. These communications are triggered when the device's processing module identifies that the frequency of the electrical power distribution has exceeded either the predetermined lower or upper frequency thresholds.

Upon detection of a frequency deviation event, the communication interface promptly initiates the transmission of alerts or notifications to designated recipients. These may include system operators, maintenance personnel, or automated management systems, among others. The alerts provide critical information regarding the nature and magnitude of the deviation, enabling rapid assessment and formulation of an appropriate response strategy.

The capability to transmit alerts and notifications ensures that stakeholders are immediately made aware of potential anomalies within the power distribution system. This prompt awareness facilitates quicker response times, potentially mitigating the impact of frequency deviations and enhancing overall system stability. Furthermore, this feature supports proactive maintenance and operational practices, contributing to the long-term reliability and efficiency of the electrical power distribution network.

The communication interface's expanded functionality allows users to securely access the device's stored frequency deviation event logs and configuration settings from any remote location. This capability is instrumental in providing system operators, maintenance personnel, and other stakeholders with the flexibility to review detailed records of frequency deviations and the corresponding responses initiated by the device. Users can examine these logs to gain insights into the sequence of events, the effectiveness of predefined thresholds, and the overall system performance during deviation events.

Moreover, the remote access feature empowers users to modify and adjust the monitoring parameters of the device, including but not limited to, the frequency threshold configurations and the moving average filter settings. By enabling these adjustments to be made remotely, the device ensures that its monitoring capabilities can be dynamically tailored to suit evolving operational requirements and conditions without the need for physical interaction.

The device is equipped with a built-in web server, allowing users to access the device's interface using a standard web browser. This web interface provides a graphical representation of the device's data and configuration settings. Secure HTTP (HTTPS) is utilized to encrypt communication between the user and the device, protecting sensitive information during transmission.

The “Filename prefix” field 124 offers users the ability to customize the prefix of log files associated with frequency deviation events. Set by default to “freqDeviation” as shown in FIG. 1, the naming convention for log files combines this prefix with the event type and the event occurrence time. The event type is determined as either an upper or lower frequency deviation event, and the event time is recorded at the moment of occurrence.

In the context of data logging, the intelligent electronic device is equipped to by default capture 400 pre-trigger and 12,000 post-trigger records, as specified in the settings under “Pre-trigger records” 125 and “Post-trigger records” 126. Users can change values of Pre-trigger records” 125 and “Post-trigger records” 126 according to their requirements.

Each record, whether categorized under pre-trigger or post-trigger, represents a calculated frequency value derived from data analyzed within the confines of a specified moving average window length. This approach to data logging is pivotal for conducting an in-depth analysis of frequency deviations within the electrical power distribution system.

Pre-trigger records encompass frequency values calculated from data obtained before the onset of a frequency deviation event. The primary function of these records is to furnish a historical backdrop, offering insights into the electrical conditions preceding the event. This historical perspective is invaluable for piecing together the sequence of events leading to a deviation, facilitating a thorough electrical analysis.

Conversely, post-trigger records consist of frequency values calculated from data collected subsequent to the identification of a frequency deviation. These records are instrumental in examining the aftermath of the deviation, shedding light on its effects on the electrical system and aiding in the assessment of the system's response.

By calculating frequency values for both pre- and post-trigger periods based on data filtered through the moving average window, the device ensures a systematic and precise measurement of frequency deviations. This methodology not only simplifies the analysis of electrical parameters but also enhances the reliability of the monitoring process, providing a solid foundation for operational decisions and system adjustments.

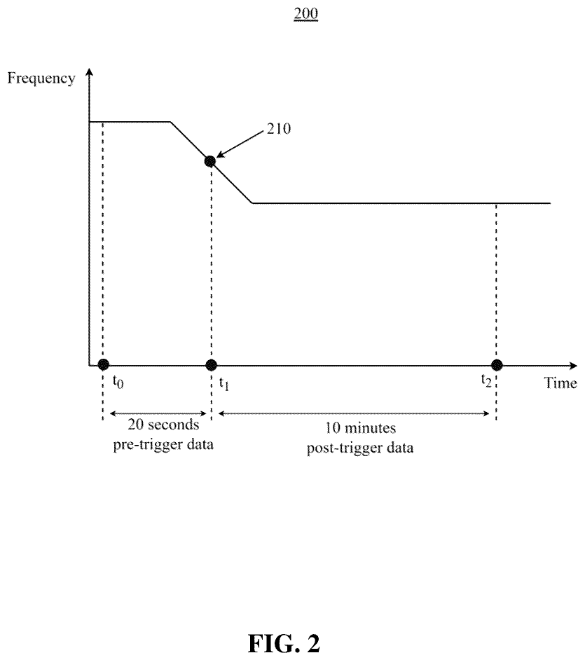

The duration covered by these log files is dependent upon the system's nominal frequency and the configured moving average filter settings. For instance, with a system nominal frequency set at 50 Hz and a moving average update rate of 2.5 cycles, the pre-trigger log duration is estimated at 20 seconds (1/50*2.5 cycles*400), and the post-trigger log is estimated at 600 seconds or 10 minutes (1/50*2.5 cycles*12,000), as elucidated in FIG. 2.

An essential addition to the user interface is a “SAVE” button 130 located at the interface's bottom. This button facilitates the preservation of all preceding configurations set by the user, ensuring that the custom settings for frequency deviation monitoring are effectively applied and maintained within the device.

FIG. 2 presents an illustrative example detailing the recording of frequency deviations, utilizing a graphical representation where the x-axis denotes time, and the y-axis represents frequency. An event labeled 210 is depicted occurring at time marker t1, characterized by a frequency measured surpassing the predetermined upper threshold. This specific event activates the recording function of the device, prompting the capture of data as measured by the device.

The diagram delineates a pre-trigger recording phase spanning 20 seconds, extending from time t₀ to time t₁. This interval is automatically documented in the log file, capturing the waveform data leading up to the event. After time t1, a post-trigger phase commences, continuing for a duration of 10 minutes until time t2. The entirety of this period is also recorded, ensuring a comprehensive dataset is compiled, encapsulating both the precursor conditions and the aftermath of the deviation event.

Consequently, for the event depicted at time t1, the device is configured to diligently record the frequency data calculated from the onset of the pre-trigger phase at to, through the event horizon, and concluding at the termination of the post-trigger phase at t2. This meticulous approach to data capture ensures an exhaustive log is maintained, offering valuable insights into the dynamics of frequency deviation events within the monitored electrical system.

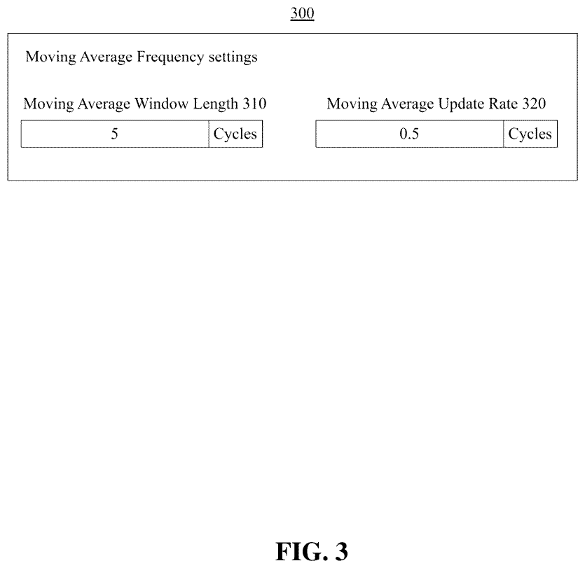

FIG. 3 delineates a user interface designed for the configuration of moving average filters within an intelligent electronic device, facilitating precise calculation of frequency. This interface enables users to meticulously set parameters for moving average window length 310 and moving average update rate 320, both expressed in units of cycles. This interface, adaptable for presentation on the device's physical display or within a device configuration webpage, offers a user-centric design that enables intuitive interaction and configuration by the end-user.

A cycle, in the context of a 50 Hz utility power signal, signifies one complete oscillation of the sinusoidal wave that characterizes the electrical power signal, integral for understanding the operational basis of the moving average filter.

Moving average window length 310: This parameter dictates the total number of signal cycles over which the moving average is computed. Configurable between 0.5 to 50 cycles, in increments of 0.5, it allows for adaptive data smoothing. For instance, setting the moving average window length to 2 cycles in a 50 Hz system entails the averaging of data over 40 milliseconds (given one cycle equates to 20 milliseconds at 50 Hz), effectively diminishing the influence of transient fluctuations on frequency and power measurements.

Moving average update rate 320: This defines the frequency at which the moving average filter recalculates its values, incorporating new data. With a permissible range of 0.5 to 50, in 0.5 cycle increments, and a constraint to not exceed the moving average window length, it offers versatility in monitoring responsiveness. A setting of 0.5, for example, updates the moving average every half cycle (or 10 milliseconds in a 50 Hz system), enhancing the system's ability to track rapid changes while still applying a degree of data smoothing.

Adjusting the moving average window length and update rate empowers users to customize the device's monitoring capabilities to align with specific requirements, ranging from stable environments with an emphasis on long-term trends to volatile settings where swift detection of issues is paramount.

The incorporation of the moving average filter configuration serves several critical purposes:
1. Data smoothing: It mitigates rapid, transient fluctuations in frequency and power data, facilitating clearer differentiation between normal variability and significant events or trends.
2. Trend detection: Averaging data across user-defined windows aids in identifying sustained shifts in frequency and power levels, potentially indicative of systemic issues or load changes.
3. Noise reduction: It counters the effects of electrical noise that can distort measurements, ensuring recorded data more accurately reflects actual conditions.
4. Customizable monitoring: Users can tailor the system's sensitivity and smoothing characteristics to their specific needs through adjustable moving average window length and update rate.
5. Enhanced log accuracy and relevance: Data processed through the moving average filter before logging ensures the information captured is both precise and pertinent, improving the utility of logs for analysis and troubleshooting.
6. Operational efficiency: These configuration options allow the device to adapt its performance to diverse conditions, optimizing functionality across different environments.

In essence, the moving average filter configuration in the energy meter is intricately designed to enhance the device's efficacy in monitoring, logging, and analyzing key electrical parameters. This system not only facilitates smoother data representation but also enables the detection of meaningful trends, contributing to more reliable and actionable insights into power quality and stability.

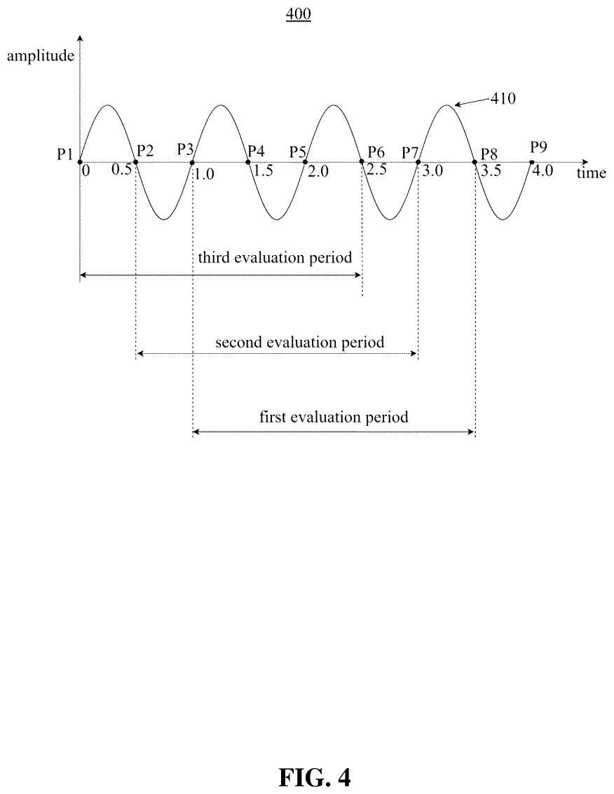

FIG. 4 is a diagram that showcases the methodology for calculating frequency using the configured moving average window length and moving average update rate parameters within an intelligent electronic device. This diagram serves as a crucial illustration of the practical application of these settings in the context of real-time electrical signal analysis.

The configuration depicted in FIG. 4 demonstrates the moving average window length set at 2.5 cycles and the moving average update rate adjusted to 0.5 cycles, applied to an electrical signal 410, which may represent either a voltage or current waveform captured by the device. In this figure, the y-axis represents the amplitude of the electrical signal 410, while the x-axis delineates time, quantified in cycles. This illustration serves to elucidate the influence of the specified filter settings on the process of data capture and analysis.

Within the graphical representation of FIG. 4, nine pivotal points, labeled P1 through P9 and denoted by solid circles, signify zero-crossing points within the signal's waveform. It is imperative to note, for clarification purposes, that while nine zero-crossing points are identified in this example for illustrative convenience, the actual selection of points in practical applications need not be confined to zero-crossing instances.

In the scenario depicted, should the device identify a frequency deviation event at point P8, and if the pre-trigger records setting of the energy meter is configured to capture 3 records, the ensuing operational process within the device unfolds as follows:
1. First evaluation period: Given the moving average window length 310 is established at 2.5 cycles, the device is tasked with recording waveform data from the segment extending between P8 and P3. This segment, designated as the first evaluation period, encompasses the requisite data for the initial frequency calculation window, herein referred to as “record 1.” It is essential to highlight that the data captured during this first evaluation period serves a pivotal role beyond mere recording. Specifically, this data is utilized as the foundational input for calculating the frequency of the electrical signal 410 during this initial window. The calculation of frequency, based on the data acquired in this period, represents the first instance of applying the moving average filter to discern frequency deviations within the monitored electrical signal.
2. Second evaluation period: With the moving average update rate 320 configured to a 0.5 cycle interval, the device proceeds to record waveform data spanning the interval between P2 and P7. This interval, identified as the second evaluation period, provides the data foundation for the subsequent frequency calculation window, and is aptly named “record 2.” The data captured during this second evaluation period is utilized as the foundational input for calculating the frequency of the electrical signal 410 during this window.
3. Third evaluation period: Continuing its operation under the defined settings, the device captures waveform data within the range from P1 to P6, marking the third evaluation period. This data, essential for the third frequency calculation window, is named “record 3.” The data captured during this third evaluation period is utilized as the foundational input for calculating the frequency of the electrical signal during this window.

This procedural description underlines the methodical approach employed by the intelligent electronic device in harnessing the configured moving average window length and update rate parameters to systematically record and analyze data pertinent to frequency deviation events. Through such precision in data acquisition and processing, the energy meter effectively leverages the moving average filter's capabilities to enhance the accuracy and relevance of frequency analysis, thereby providing a robust framework for electrical signal monitoring and evaluation.

Upon the completion of each evaluation period, the intelligent electronic device undertakes a meticulous process to calculate the frequency of the electrical signal 410 using the data encapsulated within “record 1,” “record 2,” and “record 3.” This process involves the application of the moving average filter, configured as per the device settings, to the waveform data recorded during each respective evaluation period. The calculated frequencies represent a refined analysis of the electrical signal's behavior, taking into account the adjustments made for the moving average window length and update rate.

For “record 1,” the device analyzes the data captured between P8 and P3 to compute the initial frequency. This calculation sets the precedent for frequency analysis within the device, employing the moving average filter to smooth out short-term fluctuations and provide a clear indication of frequency deviations.

In some embodiments, the data captured between P8 and P3 are fed into a Digital Signal Processing (DSP) unit within the device. The DSP unit is responsible for filtering noise and applying algorithms to extract the signal's frequency. One common method for frequency extraction is the Fast Fourier Transform (FFT), which transforms the time-domain signal into the frequency domain, allowing the meter to identify the dominant frequency components.

Similarly, “record 2” and “record 3” undergo a comparable process, where the device calculates the frequency for the second and third evaluation periods, respectively, using the waveform data recorded between P2 and P7 for the former, and P1 to P6 for the latter.

While the detailed description and FIG. 4 specifically illustrate the process of recording and analyzing pre-trigger events to calculate the frequency of an electrical signal within an intelligent electronic device, it is imperative to recognize that the methodology outlined can be equivalently applied to post-trigger event records. Those skilled in the art will appreciate that the systematic approach employed for pre-trigger data acquisition, processing, and frequency calculation is equally applicable to data captured following a frequency deviation event.

It's important to emphasize that every frequency calculation performed within the device, including those utilized for detecting frequency deviations, is processed through the moving average filters as configured in FIG. 3. This ensures consistency and accuracy across all frequency-related analyses conducted by the device.

Just as the pre-trigger records-record 1, record 2, and record 3—are analyzed to discern the frequency deviations leading up to an event, post-trigger records can be processed in a similar manner to understand the aftermath and the system's response to such deviations. This parallel analysis enables a comprehensive understanding of the entire event lifecycle, from inception to resolution. The device is designed to automatically transition to capturing post-trigger records, adhering to the same moving average window length and update rate configurations, thereby ensuring a seamless and continuous monitoring experience.

By applying the same methodological rigor to both pre-trigger and post-trigger data, the device ensures that users have access to a full spectrum of insights into the frequency behavior of the electrical system, facilitating informed decision-making and effective system management. This holistic approach to frequency deviation analysis underscores the device's advanced capabilities in providing robust and actionable intelligence for maintaining optimal power system performance.

Once the frequency for each record has been calculated, the device proceeds to store these frequencies in the log file, marking a comprehensive documentation of the frequency analysis conducted. This log file serves as a vital record, encapsulating the detailed outcomes of the moving average filter application to the electrical signal's frequency analysis over time. The inclusion of calculated frequencies in the log file not only facilitates a chronological tracing of frequency deviations but also enhances the utility of the log for future diagnostics, performance assessment, and maintenance planning. This systematic approach to frequency calculation and documentation underscores the device's advanced capabilities in real-time electrical signal analysis, ensuring that users are equipped with precise and actionable data to maintain optimal power system performance.

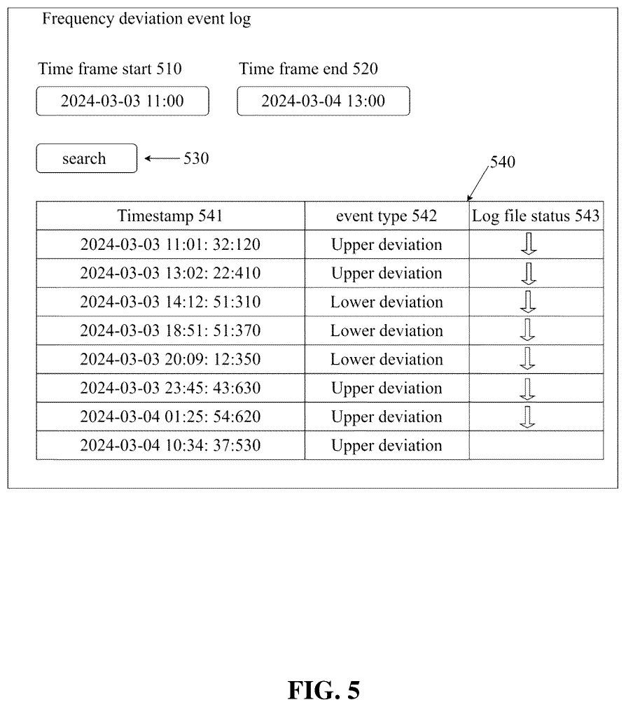

FIG. 5 illustrates a sophisticated user interface implemented within an intelligent electronic device, designed specifically to facilitate user access to critical information pertaining to frequency deviation events recorded by the device. This interface enables users to efficiently conduct searches for frequency deviation events over a specified time period, enhancing the utility and user-friendliness of the device in monitoring electrical system stability.

To initiate a search, users are provided with two text input fields: “Time frame start 510” and “Time frame end 520.” These fields allow users to define the beginning and end of the time period for which they wish to review frequency deviation events. Upon entering the desired time frame and clicking the search button 530, the device processes the request and dynamically generates a comprehensive listing of relevant frequency deviation events within the specified period.

The results of the search are presented in a structured table 540, where key information about each frequency deviation event is systematically displayed. This table includes critical data points such as:

Timestamp 541: Denoting the precise moment at which each frequency deviation event occurred, facilitating temporal analysis and correlation with other system events or operational parameters.

Event type 542: Distinguishing between upper deviation events and lower deviation events, offering insights into the nature and direction of the frequency deviations encountered by the system.

Log file status 543: Indicating the availability of a log file for each event. A log file's status is represented visually: a download arrow in the “Log file status” column signifies the successful generation and availability of a log file for the corresponding event. Conversely, the absence of a download arrow denotes a failure in log file generation for that event.

The device ensures that all pertinent event information, including timestamps, event types, and log file statuses, is captured and recorded in real-time as each frequency deviation event occurs. This proactive approach to data logging guarantees that users have immediate access to detailed, actionable information through the user interface, significantly aiding in the analysis, troubleshooting, and management of electrical system performance.

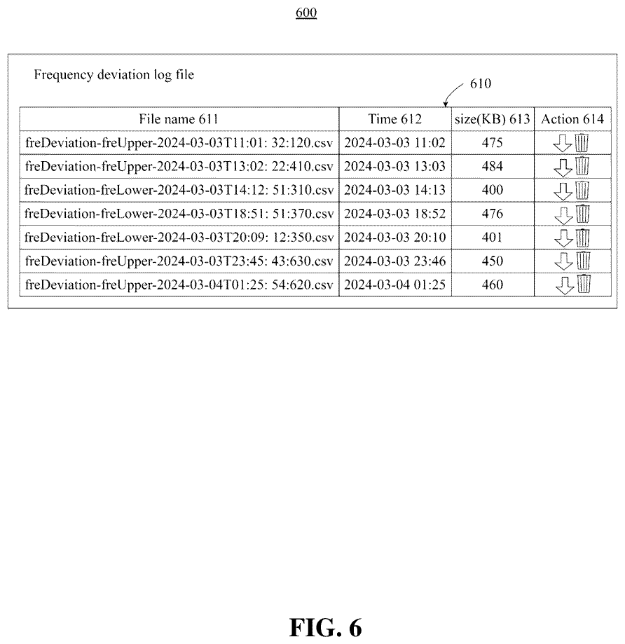

FIG. 6 depicts a sophisticated user interface on an intelligent electronic device, specifically designed for the comprehensive management of frequency deviation event log files. This interface represents an essential tool for users to efficiently access, review, and administer the log files generated by the device in response to frequency deviation events.

Central to FIG. 6 is a table 610 that meticulously organizes and displays vital information related to each log file, thereby facilitating easy user interaction and data management. The table enumerates several key attributes for each log file, including:

File name 611: Denoting the unique identifier or name assigned to each log file, enabling users to easily distinguish between multiple records.

Time 612: Indicating the precise moment the log file was created, offering insights into the timing of the frequency deviation events captured within.

Size 613: Reflecting the file size, which provides users with an understanding of the data volume contained in each log file and potentially aids in managing storage space effectively.

An additional column within the table, labeled “Action 614” introduces dynamic functionality for user interaction with each log file listed. Within this column, users are presented with intuitive controls:
A download arrow icon enables the direct downloading of log files to a local storage device, facilitating offline analysis or archiving.
A bin icon allows users to delete specific log files from the device, supporting efficient log file management and device storage optimization.

The log files themselves are comprehensive records of all frequency calculations performed by the device, as outlined in the methodology depicted in FIG. 4. These calculations underpin the device's ability to monitor and analyze frequency deviations within the electrical system it oversees, making the log files an invaluable resource for detailed event analysis and system performance evaluation.

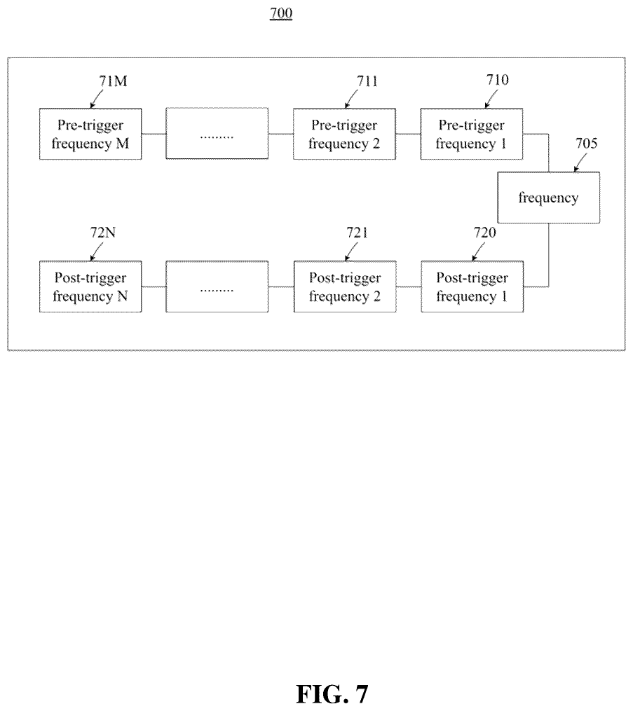

FIG. 7 presents a detailed visualization of the structured composition of a log file 700 generated for the purpose of frequency deviation detection by an intelligent electronic device. This figure provides a comprehensive overview of how frequency data, captured and computed during both the pre-trigger and post-trigger periods relative to a frequency deviation event, is meticulously documented within the log file.

The log file 700 encompasses a sequence of frequency measurements, specifically:

Pre-trigger frequencies: These are frequencies calculated and logged for various evaluation periods preceding the deviation event, as per the configuration depicted in FIG. 4. For instance:

Pre-trigger frequency 710 corresponds to frequency data calculated for the first evaluation period before the event.

Pre-trigger frequency 711 represents frequency data from the second evaluation period preceding the event.

Pre-trigger frequency 71M denotes frequency data from the M-th evaluation period before the event, where ‘M’ is determined by the pre-trigger records 125 setting, as configured by the user.

Post-trigger Frequencies: Analogously, the log file records frequencies for periods following the event, including:

Post-trigger frequency 720 for the first evaluation period subsequent to the event.

Post-trigger frequency 721 for the second post-event evaluation period.

Post-trigger frequency 72N for the N-th evaluation period after the event, with ‘N’ corresponding to the number of post-trigger records 126 specified by the user.

In addition to the detailed account of pre-trigger and post-trigger frequency measurements, the log file 700 is further enhanced to include a specific frequency measurement, labeled frequency 705, which represents the exact frequency at the moment the deviation is detected. This critical data point, frequency 705, like all other frequency calculations within the device, is derived using the moving average filters as outlined in the configuration depicted in FIG. 3.

Additionally, the log file 700 contains detailed settings related to the device's moving average frequency analysis, including the moving average window length 310 and the moving average update rate 320. These settings are crucial as they influence the frequency calculation process, thereby providing context to the frequency data recorded.

The inclusion of both pre-trigger and post-trigger frequency data, along with the configuration settings for the moving average frequency analysis, equips users with a robust dataset for comprehensive analysis. This dataset not only aids in understanding the dynamics leading up to and following a frequency deviation event but also allows for the evaluation of the device's frequency detection sensitivity based on user-defined parameters.

FIG. 7 underscores the intelligent electronic device's capability to generate detailed and actionable logs for frequency deviation events. By archiving this intricate blend of calculated frequencies and configuration settings, the log file serves as an indispensable tool for monitoring, diagnosing, and optimizing power distribution networks, demonstrating the device's advanced functionality in electrical system management.

In some embodiments, the intelligent electronic device integrates a comprehensive data storage module specifically designed to archive occurrences of frequency deviation within the electrical power distribution system. This module plays a pivotal role in the device's ability to monitor and analyze the stability and efficiency of power distribution.

The data storage module is engineered with the capacity to systematically capture and preserve log files that are initiated upon the detection of frequency deviation events. This initiation is tied to the activation of a predefined trigger event, which is determined based on the deviation of frequency measurements from established lower or upper thresholds.

Each log file generated and stored within this module is meticulously structured to include timestamped entries. These entries chronicle the frequency data measured both before (pre-trigger) and after (post-trigger) the occurrence of a deviation event. The inclusion of timestamps with each entry allows for the construction of a detailed chronological narrative, elucidating the behavior of the electrical power distribution's frequency as it fluctuates in response to various conditions and incidents.

Pre-trigger Data: This subset of the log file records the frequency measurements leading up to the trigger event. It captures the baseline stability or instability of the system, offering invaluable insights into the preconditions that may contribute to frequency deviations.

Post-trigger Data: In contrast, this data captures the frequency measurements following the event, documenting the immediate and subsequent effects of the deviation on the power distribution system. This aids in assessing the system's response and the efficacy of any corrective actions taken.

Deviation Event Timestamp: To enhance the utility of the log files further, each file also documents the precise moment the deviation occurs, marked by a specific deviation event timestamp. This critical addition ensures that the transition between pre- and post-trigger conditions is clearly defined within the historical record.

The systematic storage of these log files within the data storage module ensures that historical data is readily available for analysis. This capability is crucial for diagnosing issues, optimizing system performance, and planning preventive maintenance. By providing a chronological account of frequency deviations and the system's response, the data storage module empowers operators and engineers with the knowledge needed to enhance the reliability and efficiency of electrical power distribution.

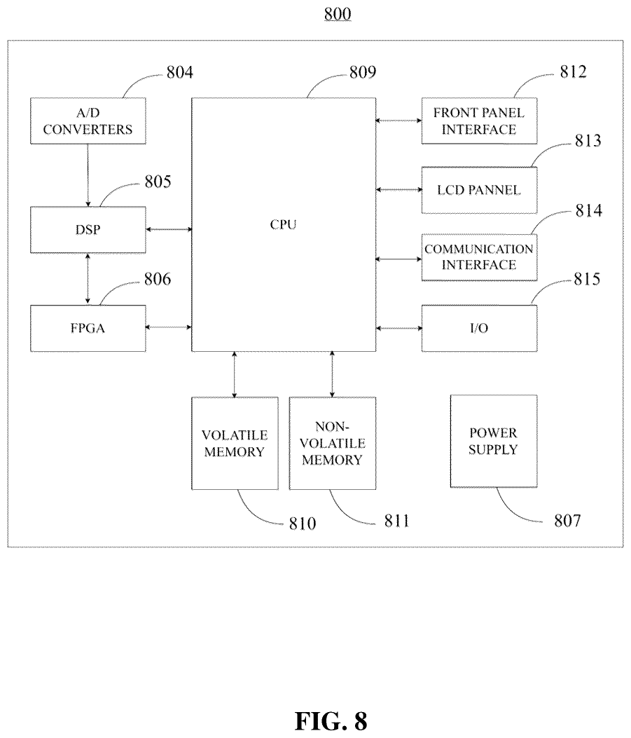

FIG. 8 is a block diagram of an intelligent electronic device 800 for sensing electrical parameters and computing data within an electrical system.

The intelligent electronic device 800 includes multiple analog-to-digital (A/D) converters 804, a power supply 807, volatile memory 810, non-volatile memory 811, a front panel interface 812, and a processing module that includes at least one Central Processing Unit (CPU) and/or one or more Digital Signal Processors (DSP), two of which are shown DSP 805 and CPU 809. The intelligent electronic device 800 also includes a Field Programmable Gate Array (FPGA) 806 which performs several functions, including acting as a communications bridge for transferring data between the various processors (805 and 809).

The output of a current transformer or potential transformer will be coupled with the A/D converters 804 which are configured to convert the analog voltage output from the transformer to a digital signal that can be processed by the DSP 805.

The output from the current transformer or potential transformer, which serve as sensors for sensing electrical parameters of electrical power distributed from an electrical distribution system to a load, is critical for accurate monitoring and analysis of electrical systems. These transformers capture vital parameters such as current and voltage levels, respectively, thereby facilitating a detailed understanding of the power flow and its characteristics within the system.

A/D converters 804 are configured to convert an analog voltage output to a digital signal that is transmitted to a gate array, such as Field Programmable Gate Array (FPGA) 806. The digital signal is then transmitted from the FPGA 806 to the CPU 809.

The CPU 809 or DSP Processors 805 are configured to receive digital signals from the A/D converters 804 and perform the necessary calculations to determine power usage and control the overall operations of the intelligent electronic device 800. In some embodiments, the CPU 809 and DSP 805 may be combined into a single processor to serve the functions of each component. In some embodiments, it is contemplated to use an Erasable Programmable Logic Device (EPLD), a Complex Programmable Logic Device (CPLD), or any other programmable logic device in place of the FPGA 806. In some embodiments, the digital samples, which are output from the A/D converters 804 are sent directly to the CPU 809, effectively bypassing the DSP 805 and the FPGA 806 as a communications gateway.

The power supply 807 provides power to each component of the intelligent electronic device 800. In one embodiment, the power supply 807 is a transformer with its primary windings coupled to the incoming power distribution lines to provide a nominal voltage at its secondary windings. In other embodiments, power may be supplied from an independent power source to the power supply 807.

The front panel interface 812 is shown coupled to the CPU 809 which includes indicators, switches, and various inputs. The LCD panel 813 is shown coupled to the CPU 809 for interacting with a user and for communicating events, such as alarms and instructions. The LCD panel 813 may provide information to the user in the form of alpha-numeric lines, computer-generated graphics, videos, animations, etc.

An input/output (I/O) interface 815 may be provided for receiving externally generated inputs from other devices and for outputting data, such as serial data, to other devices. In one embodiment, the I/O interface 815 may include a connector for receiving various cards and/or modules that increase and/or change the functionality of the intelligent electronic device 800.

The intelligent electronic device 800 also includes volatile memory 810 and non-volatile memory 811. The volatile memory 810 will store the sensed and generated data for further processing and for retrieval when requested to be displayed at intelligent electronic device 800 or from a remote location. The volatile memory 810 includes internal storage memory, such as Random-Access Memory (RAM). The non-volatile memory 811 includes removable memory, such as magnetic storage memory, optical storage memory (such as various types of CD or DVD media), solid-state storage memory, (such as a CompactFlash card, a Memory Stick, SmartMedia card, MultiMediaCard [MMC], SD [Secure Digital] memory), or any other memory storage that exists currently or will exist in the future. Such memory will be used for storing historical trends, waveform captures, event logs (including timestamps), and stored digital samples for later download to a client application, webserver, or PC application.

In a further embodiment, the intelligent electronic device 800 will include a communication interface 814, also known as a network interface, for enabling communications between the meter, and a remote terminal unit or programmable logic controller and other computing devices, microprocessors, desktop computers, laptop computers, other meter modules, etc. The communication interface 814 may be a modem, Network Interface Card (NIC), wireless transceiver, or other interface. The communication interface 814 will operate with hardwired and/or wireless connectivity. A hardwired connection may include, but is not limited to, physical cabling (such as parallel cables serial cables, RS232, RS485, USB cables, or Ethernet) and an appropriately configured communication port. The wireless connection may operate under any of the various wireless protocols including, but not limited to, Bluetooth™ interconnectivity, infrared connectivity, radio transmission connectivity (including computer digital signal broadcasting and reception commonly referred to as Wi-Fi or 802.11.X [where x denotes the type of transmission]), satellite transmission, or any other type of communication protocols, communication architecture, or systems currently existing or to be developed for wirelessly transmitting data.

The intelligent electronic device 800 may communicate to a server or other computing device via the communication interface 814. The intelligent electronic device 800 may be connected to a communications network (such as the Internet) by any means. For example, a hardwired or wireless connection, such as dial-up, hardwired, cable, DSL, satellite, cellular, PCS, or wireless transmission (e.g., 802.11a/b/g) may be used. It is noted that the network may be a Local Area Network (LAN), Wide Area Network (WAN), the Internet, or any network that couples multiple computers to enable various modes of communication via network messages. Furthermore, the server will communicate using various protocols, such as Transmission Control Protocol/Internet Protocol (TCP/IP), File Transfer Protocol (FTP), or Hypertext Transfer Protocol (HTTP) or via secure protocols such as Hypertext Transfer Protocol Secure (HTTPS), Internet Protocol Security Protocol (IPSec), Point-to-Point Tunneling Protocol (PPTP), Secure Sockets Layer (SSL) Protocol, or via other secure protocols. The server may further include a storage medium for storing the data received from at least one IED or meter and/or storing data to be retrieved by the IED or meter.

In an additional embodiment, when a power event occurs, such as a voltage surge, voltage sag, or current short circuit, the intelligent electronic device 800 may also have the capability of not only digitizing waveforms but storing the waveform and transferring that data upstream to a central computer, such as a remote server. The power event may be captured, stored to memory (e.g., non-volatile RAM), and additionally transferred to a host computer within the existing communication infrastructure either immediately, in response to a request from a remote device or computer, or later in response to a polled request. The digitized waveform will also allow the CPU 809 to compute other electrical parameters such as harmonics, magnitudes, symmetrical components, and phasor analysis.

In a further embodiment, the intelligent electronic device 800 will execute an e-mail client and will send notification e-mails to the utility or directly to the customer when a power quality event occurs. This allows utility companies to dispatch crews to repair the condition. The data generated by the meters is used to diagnose the cause of the condition. The data is transferred through the infrastructure created by the electrical power distribution system. The e-mail client will utilize POP3 or another standard e-mail protocol.

The techniques of the present disclosure can be used to automatically maintain program data and provide field-wide updates upon which power meter firmware and/or software can be upgraded. An event command can be issued by a user, on a schedule, or through a digital communication that will trigger the intelligent electronic device 800 to access a remote server and obtain the new program code. This will ensure that program data will be maintained, assuring the user that all information is displayed identically on all units.

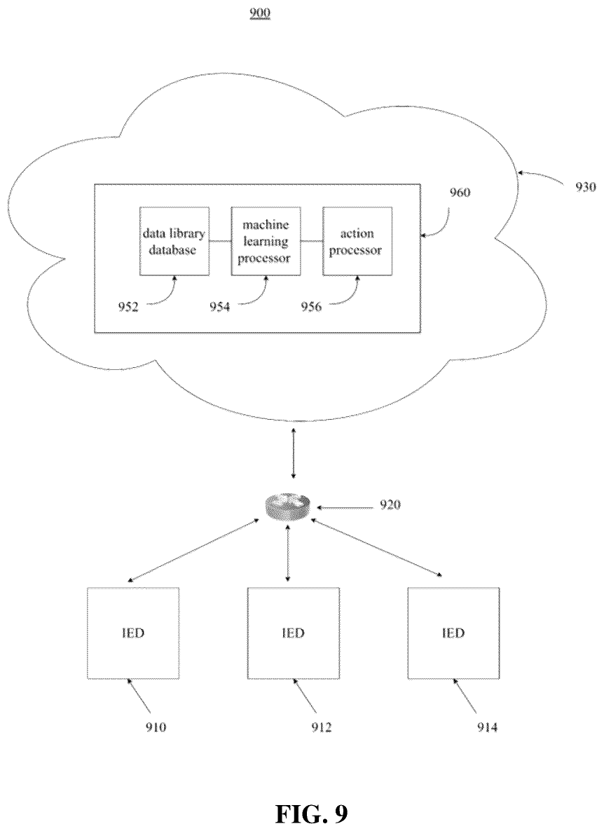

FIG. 9 illustrates an exemplary electrical power monitoring and management system 900. The system 900 includes a network of intelligent electronic devices (IEDs) designated as IED 910, IED 912, and IED 914. These devices are dispersed across various locations within an electrical power distribution network to perform comprehensive monitoring tasks. Each IED is adept at sensing crucial electrical parameters such as current, voltage, and frequency, vital for maintaining the stability and efficiency of the power distribution network.

The core functionality of these IEDs includes the capability to compute the frequency of the electrical power distribution. This computation is enhanced by the use of customized moving average filters, which are instrumental in refining the frequency measurement. This refinement process is crucial for adjusting for short-term fluctuations and noise, thereby significantly enhancing the accuracy of the frequency analysis. Moreover, each IED is equipped to log the computed frequency data, encapsulating both pre-trigger and post-trigger events related to frequency deviations. These logs include timestamped entries, providing a detailed chronological account of each detected deviation event. Subsequently, the measured electrical parameters and the meticulously logged frequency data are transmitted to a central energy management module for further analysis and action.

The central energy management module, depicted as module 960 within the cloud 930 environment, represents the analytical and decision-making hub of the system. This module houses several key components, including:

A data library database 952, tasked with storing a multitude of data samples received from the deployed IEDs. These data samples are categorized into two primary sets: a first trained set derived from historical readings by one or more IEDs and a second trained set based on live readings. These readings encompass various electrical parameters, along with pre-trigger and post-trigger frequency data related to frequency deviation events, each associated with a specific timestamp.

A machine learning processor 954, located within the central energy management module, is designed to meticulously process the data samples using sophisticated machine learning algorithms. This processor is configured to identify patterns, trends, and potential anomalies in the frequency data across the power distribution network, thereby facilitating the dynamic adjustment of the moving average filter settings for each IED.

An action processor 956, which receives predictions from the machine learning processor and is responsible for adjusting the moving average filter settings of each IED based on these received predictions. This adjustment process is pivotal in enhancing the system's precision in detecting frequency deviations and tailoring the responsiveness of each IED to meet specific environmental and operational conditions.

Access to the cloud 930, and thus to the central energy management module 960, is facilitated by a router 920, which serves as a gateway for IEDs 910, 912, and 914, ensuring seamless communication and data transmission to the cloud-based module.

At the heart of the system's advanced capabilities is the machine learning processor 954, a component of the central energy management module 960. This processor is also tasked with the critical analysis of comprehensive data samples, stored within the data library database 952. Utilizing advanced machine learning algorithms, it embarks on an analytical journey through both historical and real-time data streams of voltage, current, and frequency, along with detailed records of pre-trigger and post-trigger events. The outcome of this analysis is the generation of predictive insights regarding frequency stability over designated future intervals.

Armed with these predictive insights, the action processor 956 activates, translating the analytical predictions into actionable intelligence. It orchestrates the generation of control signals aimed at specific IEDs within the network, designed to adjust or discontinue the operation of certain loads whenever the anticipated frequency stability breaches set thresholds. This proactive mechanism is instrumental in preempting risks and bolstering the resilience and equilibrium of the electrical power distribution network.

In FIG. 9, the electrical power monitoring and management system is equipped with a sophisticated infrastructure designed to optimize the monitoring and management of electrical power distribution networks. Central to this system's efficacy is the incorporation of a server, pivotal in orchestrating the operation of the central energy management module deployed within a cloud computing environment.

The server is an integral component of the central energy management module, featuring at least one processor and a memory unit. The memory unit is tasked with housing the data library database, a comprehensive repository of data samples meticulously collected from the intelligent electronic devices (IEDs)—IED 910, IED 912, and IED 914, as visualized in FIG. 9. These samples encompass a broad spectrum of electrical parameters, including but not limited to voltage, current, and frequency measurements, alongside the nuanced data of pre-trigger and post-trigger events related to frequency deviations. This rich dataset is further augmented with historical readings and live data streams, each tagged with precise timestamps, ensuring a granular level of analysis and actionable insights.

The server's processor plays a critical role in facilitating the execution of the machine learning processor and the action processor. The machine learning processor leverages advanced algorithms to sift through the amassed data, drawing predictive models and insights that inform the operational adjustments required within the network. These predictions, particularly regarding the moving average filter settings for each deployed IED, are instrumental in enhancing the precision of frequency deviation detection and in customizing the response mechanisms of the IEDs based on evolving environmental and operational conditions.

By enabling the execution of sophisticated machine learning algorithms, the server not only amplifies the system's analytical capabilities but also empowers the action processor to implement targeted interventions. These interventions, guided by the predictive analytics, are designed to maintain or restore the optimal frequency stability across the network, thus ensuring the uninterrupted integrity and efficiency of power distribution.

The central energy management module 960 houses a machine learning processor 954, which stands at the forefront of analyzing electrical parameter data, including but not limited to current, voltage, and frequency measurements. The incorporation of an array of sophisticated machine learning algorithms, such as Artificial Neural Networks, Backpropagation techniques, Deep Learning methodologies, Convolutional Neural Networks, Recurrent Neural Networks, and Evolution Algorithms, empowers the machine learning processor to delve deep into the data received. This processor meticulously sifts through both historical readings and live data streams to discern underlying patterns, trends, and potential deviations that may indicate frequency instability or other systemic issues within the power distribution network.

Artificial Neural Network (ANN) can be structured to input multiple features extracted from the historical and live readings, such as voltage, current, and frequency values, along with contextual information like the time of day and pre-trigger and post-trigger event data. The output layer of the ANN would predict the optimal settings for the moving average filters. Training involves adjusting network weights based on historical data where the efficacy of various filter settings on system stability was observed, using a cost function that minimizes prediction errors. Similarly, Artificial Neural Network can also be used to predict frequency stability in the different areas within an electrical power distribution network in a predetermined future time.

Steps to develop an Artificial Neural Network (ANN) capable of predicting the optimal settings for moving average filters in an electrical power monitoring and management system include:

### 1. Define the ANN Structure

First, decide on the architecture of the ANN. A simple yet effective structure might consist of an input layer, several hidden layers, and an output layer. Each layer will have a number of neurons (or nodes). For this application, consider using:

Input Layer: Number of neurons corresponding to the number of features (e.g., voltage, current, frequency, time of day, and event data indicators).

Hidden Layers: Two or three hidden layers with a varying number of neurons. A common practice is to experiment with different numbers of neurons and layers to find the best architecture.

Output Layer: Two neurons, each predicting the optimal setting for the moving average filter's window length and update rate.

### 2. Input Features

Extract and preprocess input features from both historical and live readings. Features include:

Voltage, current, and frequency measurements.

Time of day, to capture daily patterns.

Pre-trigger and post-trigger event indicators (binary values indicating the presence of an event).

Normalization or standardization of these features might be necessary to improve training efficiency and accuracy.

### 3. Output Prediction

The ANN predicts two continuous values:

Optimal moving average window length.

Optimal moving average update rate.

These values are determined based on the historical efficacy of different settings on system stability.

### 4. Training the ANN

Training involves using historical data where the outcomes of various filter settings on system stability were recorded. The steps include:

Split the historical data into training and validation sets.

Define a cost function that quantifies the prediction error (e.g., Mean Squared Error (MSE) between the predicted optimal settings and the settings that historically led to the best system performance).

Use an optimization algorithm (e.g., stochastic gradient descent) to adjust the network weights and minimize the cost function over multiple epochs.

To predict frequency stability in different areas within an electrical power distribution network using an Artificial Neural Network (ANN), it's crucial to design a model that can interpret the complex relationships between various electrical parameters and environmental factors. This task requires a detailed approach to model architecture, feature engineering, training, and implementation.

### 1. Model Architecture

For predicting frequency stability, a similar architecture to the one used for predicting moving average filters can be utilized but tailored to output frequency stability predictions:

Input Layer: Matches the number of input features.

Hidden Layers: Two or three layers, experimenting with different numbers of neurons.

Output Layer: One neuron if predicting a single stability metric, or multiple if predicting several stability-related metrics.

### 2. Input Features

The model inputs should include both raw electrical measurements and derived features that could influence frequency stability:

Raw inputs: Voltage, current, and frequency measurements.

Temporal inputs: Time of day, day of the week, and possibly season.

Event-related inputs: counts of pre-trigger and post-trigger events.

Environmental inputs: Weather conditions, if available, as they can affect system load and stability.

### 3. Output Prediction

The output is a prediction of frequency stability, which could be:

A binary classification (stable vs. unstable).

A continuous value representing a stability score or the probability of instability in the near future.

### 4. Training Process

Training the ANN involves using historical data with known outcomes of frequency stability incidents:

Divide the data into training, validation, and test sets.

Choose a loss function appropriate for the output type (e.g., binary crossentropy for classification, mean squared error for continuous outputs).

Use an optimizer like Adam for adjusting weights to minimize the loss function.

Deep Learning, particularly deep neural networks, can handle the high dimensionality of electrical parameter data and identify complex, nonlinear relationships. Layers of neurons learn hierarchical representations of the data, with initial layers detecting simple patterns and deeper layers recognizing more abstract features relevant to predicting the optimal settings for the moving average filters. Similarly, Deep Learning can also be used to predict frequency stability in the different areas within an electrical power distribution network in a predetermined future time.

Convolutional Neural Networks (CNNs) can effectively process time-series data by treating temporal sequences as one-dimensional “images.” Each layer of the network applies a set of filters to detect features in the time-series data, such as trends or sudden changes in voltage, current, and frequency, which precede frequency deviations. Pooling layers reduce the dimensionality of the data, making the network efficient and focused on the most salient features for predicting filter settings. Similarly, CNNs can also be used to predict frequency stability in the different areas within an electrical power distribution network in a predetermined future time.

Recurrent Neural Networks (RNNs) are particularly suited for sequential data, making them ideal for analyzing time-series readings from IEDs. By maintaining a form of memory over input sequences, RNNs can use the context of previous electrical readings and events to predict future system behavior. This capability enables the RNN to suggest moving average filter settings that account for the temporal dynamics of the power distribution network, such as cyclical load variations or recurrent instability patterns. Similarly, RNNs can also be used to predict frequency stability in the different areas within an electrical power distribution network in a predetermined future time.

Evolution Algorithms (EAs) optimize the selection of moving average filter settings through iterative improvement. Starting with a population of potential solutions (filter settings), the EA evaluates each solution's fitness based on a set of criteria, such as minimizing frequency deviations. Genetic operators like selection, crossover, and mutation are applied to evolve the population towards optimal solutions. The historical and live data act as the environment in which these solutions are tested, allowing the EA to adapt the filter settings to the specific characteristics of the electrical distribution network. Similarly, EAs can also be used to predict frequency stability in the different areas within an electrical power distribution network in a predetermined future time.

The machine learning processor within the central energy management module will utilize these algorithms to process and analyze the vast dataset stored in the data library database. By continuously training on both historical and live data, the processor can refine its predictions for each IED's moving average filter settings, aiming to maintain or enhance network stability and performance. The output of these algorithms directly informs the action processor, enabling real-time adjustments across the network.

The utilization of these advanced algorithms facilitates a comprehensive analysis that extends beyond simple data aggregation. By harnessing the predictive power of machine learning, the processor can forecast potential frequency stability challenges and predict future states of the power distribution network with remarkable accuracy. This predictive capability enables the action processor 956 within the central energy management module to take preemptive measures to address anticipated issues before they escalate.

While the foregoing descriptions illustrate the present invention in the context of a three-phase power meter, it should be recognized that the principles and teachings of the invention are equally applicable to multi-channel power meters. Those of ordinary skill in the art will appreciate that the inventive concepts disclosed herein can be adapted for use in power meters capable of monitoring multiple channels, thereby extending the utility and application of the invention beyond the specific example of a three-phase power meter.

Embodiments of the teachings of the present disclosure have been described in an illustrative manner. It is to be understood that the terminology that has been used, is intended to be in the nature of words of description rather than of limitation. Many modifications and variations of the embodiments are possible in light of the above teachings. Therefore, within the scope of the appended claims, the embodiments can be practiced other than specifically described.

What is claimed is:

1. An intelligent electronic device comprising:
at least one sensor configured for sensing electrical parameters of electrical power distributed from an electrical distribution system to a load;
at least one analog-to-digital converter coupled to the at least one sensor and configured for converting an analog signal output from the at least one sensor to digital data;
at least one processing module coupled to the at least one analog-to-digital converter, the at least one processing module is configured to:
retrieve a frequency threshold configuration from a memory unit, defining operational frequency boundaries through specified lower and upper frequency thresholds to maintain predetermined operational standards;
compute the frequency of the electrical power distribution from the digital data using customized moving average filters, which refine the frequency measurement by adjusting for short-term fluctuations and noise, thereby enhancing the accuracy of the frequency analysis;
log the refined frequency data for periods both preceding and following a trigger event, which is activated upon the detection of frequency measurements exceeding the specified lower or upper frequency threshold, ensuring detailed and actionable logging for event analysis.

2. The intelligent electronic device of claim 1 further comprising a user interface module configured to:
display a frequency threshold configuration interface to the user, allowing for the input and adjustment of the specified lower and upper frequency thresholds within the frequency threshold configuration.

3. The intelligent electronic device of claim 2, wherein the user interface module is further configured to:
enable users to customize the parameters of the moving average filters, including the moving average window length and moving average update rate, wherein the moving average window length determines the number of signal cycles over which the moving average is calculated, and the moving average update rate specifies how frequently the moving average calculation is updated with new data.

4. The intelligent electronic device of claim 2, wherein the user interface module is further configured to:
permit users to enable or disable the frequency deviation monitoring feature, thereby facilitating operational flexibility and control over the monitoring of electrical power distribution anomalies.

5. The intelligent electronic device of claim 3, wherein the user interface module is further configured to:
enable users to configure the quantity of pre-trigger and post-trigger records, each record being the frequency calculated from data within the specified moving average window length.

6. The intelligent electronic device of claim 5, further comprising a data storage module for archiving the frequency deviation events, configured to:
systematically store log files generated upon the activation of the trigger event, wherein each log file includes timestamped entries of pre-trigger and post-trigger frequency data, providing a chronological account of the electrical power distribution's frequency before and after each detected deviation.

7. The intelligent electronic device of claim 1, further comprising a communication interface configured to:
transmit alerts or notifications based on the detection of frequency deviations that exceed the predetermined lower or upper thresholds, facilitating immediate awareness and response to potential power distribution anomalies.

8. The intelligent electronic device of claim 7, wherein the communication interface is further configured to:
enable remote access to the frequency deviation event logs and configuration settings, allowing users to review and adjust monitoring parameters from a distance, enhancing the usability and accessibility of the device's monitoring features.

9. A method for monitoring and analyzing electrical power distribution using an intelligent electronic device, comprising the steps of:
sensing electrical parameters of electrical power distributed from an electrical distribution system to a load using at least one sensor;
converting an analog signal output from the at least one sensor to digital data via at least one analog-to-digital converter;
retrieving a frequency threshold configuration from a memory unit, which defines operational frequency boundaries through specified lower and upper frequency thresholds;
computing the frequency of the electrical power distribution from the digital data using customized moving average filters to refine the frequency measurement by adjusting for short-term fluctuations and noise;
logging the refined frequency data for periods both preceding and following a trigger event, activated upon the detection of frequency measurements exceeding the specified lower or upper frequency thresholds.

10. The method of claim 9, further comprising the step of:
displaying a frequency threshold configuration interface to the user via a user interface module, allowing for the input and adjustment of the specified lower and upper frequency thresholds.

11. The method of claim 9, further comprising the step of:
enabling users to customize parameters of the moving average filters, including the moving average window length and moving average update rate, through the user interface module, wherein the moving average window length determines the number of signal cycles over which the moving average is calculated, and the moving average update rate specifies the frequency at which the moving average calculation is updated with new data.

12. The method of claim 9, further comprising the step of:
permitting users to enable or disable the frequency deviation monitoring feature via the user interface module, thereby facilitating operational flexibility and control over the monitoring of electrical power distribution anomalies.

13. The method of claim 9, further comprising the step of:
configuring the quantity of pre-trigger and post-trigger records through the user interface module, with each record being the frequency calculated from data within the specified moving average window length.

14. The method of claim 9, further comprising the step of:
systematically storing log files generated upon the activation of the trigger event within a data storage module, wherein each log file includes timestamped entries of pre-trigger and post-trigger frequency data.

15. The method of claim 9, further comprising the step of:
transmitting alerts or notifications based on the detection of frequency deviations that exceed the predetermined lower or upper thresholds through a communication interface, facilitating immediate awareness and response to potential power distribution anomalies.

16. The method of claim 9, further comprising the step of:
enabling remote access to the frequency deviation event logs and configuration settings via the communication interface, allowing users to review and adjust monitoring parameters from a distance.

17. An electrical power monitoring and management system, comprising:
a plurality of intelligent electronic devices (IEDs) deployed across different areas within an electrical power distribution network, with each IED configured to:
sense electrical parameters including at least one of current, voltage, and frequency,
compute frequency of the electrical power distribution using customized moving average filters,
log the computed frequency data along with timestamped entries of pre-trigger and post-trigger events related to frequency deviations, and
transmit the measured electrical parameters and logged frequency data to a central energy management module;
a central energy management module deployed in a cloud computing environment, comprising:
a data library database configured to store a multitude of data samples received from the deployed IEDs, wherein the data samples include a first trained set based on historical readings by one or more IEDs, a second trained set based on live readings of the one or more IEDs; the historical readings and the live readings include at least one of voltage, current and frequency value measured, along with pre-trigger and post-trigger frequency data for frequency deviation events by one or more IEDs over a period of time, each value of the historical readings and the live readings being associated with a timestamp;
a machine learning processor within the central energy management module, designed to process the data samples using at least one machine learning algorithm, the machine learning processor configured to process the data samples in accordance with the at least one machine learning algorithm and output prediction of the moving average filter settings of each IED; and
an action processor configured to receive predictions from the machine learning processor and adjust the moving average filter settings of each IED based on the received predictions, thereby enhancing the system's frequency deviation detection precision, and customizing IED responsiveness based on specific environmental and operational conditions.

18. The electrical power monitoring and management system of claim 17, wherein the machine learning processor is further configured to process the data samples in accordance with the at least one machine learning algorithm and output at least one prediction of frequency stability in the different areas within an electrical power distribution network in a predetermined future time interval based on the data samples received; and the action processor is further configured to receives the at least one prediction of at least one prediction of frequency stability from the machine learning processor and perform at least one action based on the at least one prediction of frequency stability, wherein the action includes generating at least one control signal and outputting the at least one control signal to at least one of the one or more IEDs,
wherein the control signal is configured to shut off one or more loads associated with the at least one of the one or more IEDs when the at least one prediction of frequency stability is above a predetermined threshold.

19. The electrical power monitoring and management system of claim 17, further comprising a server including at least one memory and at least one processor, the data library database stored in the at least one memory and the machine learning processor and the action processor executed by the at least one processor.

20. The electrical power monitoring and management system of claim 17, wherein the at least one machine learning algorithm includes at least one of an Artificial Neural Network, Deep Learning, a Convolutional Neural Network, a Recurrent Neural Network, and/or an Evolution Algorithm.
